(19) United States
(12) Patent Application Publication
(10) Pub. No.: US 2021/0023571 A1
(43) Pub. Date: Jan. 28, 2021

(54) INDUSTRIAL ELECTROSTATIC PRECIPITATOR WITH SWITCHING ON/OFF OF ELECTRODES IN FIXED ORDER AND VARIABLE TIMES

(71) Applicant: José Simões Berthoud, Victoria (BR)

(72) Inventor: José Simões Berthoud, Victoria (BR)

(21) Appl. No.: 15/576,608

(22) PCT Filed: Aug. 31, 2017
(86) PCT No.: PCT/BR2017/000109

§ 371 Date: Nov. 22, 2017

(30) Foreign Application Priority Data
Aug. 18, 2017 (BR) 202017017803 5

(51) Int. Cl. B03C 3/68; B03C 3/47; B03C 3/08

(52) U.S. Cl. CPC B03C 3/68; B03C 3/08; B03C 3/47

(57) ABSTRACT

It is an electrostatic precipitator programmed with selective, individual, fixed sequential switching from the first emission electrode (2), comprised of the electrodes (2.1), (2.2) and (2.3), and onwards, acting so that it will provide the best possible situation for reducing suspended particulate, directing them to accumulate (B) in the collector plates (1) of the precipitator; in such a way that, with indication of the obligation to start the switch on the electrode (2.1) can produce a potential gain of efficiency together with the voltage increase that will be used in the present technology and that determines that the main accumulation occurs in the first electrode, that is, this form of sequencing conditions establishes the best operation of the technology; and thus, resulting in the gain of efficiency and potential reduction of this pollution released to the environment.

This utility model is referred to an industrial electrostatic precipitator with fixed-order emitter electrodes, more specifically to a sequential, individual, sequential, selective, switch-on electrostatic precipitator model fixed from the first electrode and onwards, acting in order to obtain the best collection efficiency as possible.

The current models of Industrial Electrostatic Precipitators only allow the simultaneous disconnection of all the emission electrodes of a same corridor and also of all the parallel corridors of the same chamber, for such operation. These models provide the precipitation of suspended particulates; however, there is not much efficiency in the collection of very thin material, since much of the suspended fine material passes through the corridors without precipitation.

In this sense, it is also of current technical knowledge the State of the Art document is a PI 9500333-9—Invention Patent for: “ELECTROSTATIC PRECIPITATOR”. An electrostatic precipitator comprising a plurality of spaced parallel dust collecting electrodes, each set including a plurality of rectangular dust collecting electrodes juxtaposed relative to each other.

The dust collecting electrode assemblies are arranged sequentially so that the surfaces of the dust collecting electrodes are oriented parallel to the flow direction of a gas to be treated. Also included is a plurality of discharge electrode assemblies, each including a plurality of rectangular discharge electrodes having saw tooth portions on both its edges.

These discharge electrodes are juxtaposed as the dust collecting electrodes, and the discharge electrode assemblies are arranged as the dust collecting electrode assemblies.

Each set of discharge electrodes is inserted between the two adjacent sets of dust collecting electrodes. The predetermined spacing between the dust collecting electrodes or the discharge electrodes by the first and second spacing adjustment devices can be narrowed sequentially from the upstream gas flow direction. The predetermined spacing between the dust collecting electrode assemblies and the discharge electrode assemblies may also be narrowed sequentially from the upstream gas flow direction.

PI0803632-2 A2 ELECTROSTATIC PRECIPITATOR OF THE TYPE MOVING ELECTRODE. The present invention relates to an electrostatic precipitator of the moving electrode type capable of reducing the extension of endless streams even if the particulate trap is operated for a long period and which increases the performance of the collection of particles. In an electrostatic precipitator of the electrode type moving to capture particles in a gas in particulate collection electrode plates, by means of the corona discharge from the discharge electrodes, by circularly moving the endless chains in which the electrode plates collecting particles are suspended such that the particulate collecting electrode plates are circularly moved, the ripple ratio of a voltage applied to the discharge electrodes is adjusted to 10% or less. A high frequency radio generator, provided with a semiconductor switch, for example, may be used as a power supply unit to obtain a high voltage direct current power supply having the ripple ratio of 10% or less

PI0503469-8 Instituting “Electrostatic Precipitator with On/Off Switching” Selective and Individual Emission Electrodes “where it refers to a type of Electrostatic Precipitator model characterized by the fact that it is capable of selectively and individually connecting/disconnecting the electric power of the emission electrodes, thus allowing a redistribution of collected mass. This is done through a direct action on the electrodes where the localized sparks occur, through a more efficient performance of the Automatic Controller System, allowing longer time intervals for the Mechanical Beat System to be triggered, resulting in an increase in the Collecting Efficiency and of the Electrostatic Precipitator Lifetime. Such a precipitator allows a reasonable increase in the collection of fine suspended particulate material, however, it still comprises a limitation as to the actual efficiency of the invention, since, in spite of providing sequential shutdown of any electrode of the initial region of the corridor, it does not specify that the only correct sequence, as observed by the practical use of said technique, must always start at the first electrode. Such limitation is determinant for the maximum non-gain in collection efficiency that new technology can make possible.

The state of the art cited in PI 9500333-9 is the origin of the first patent registered as PRECIPITADOR ELETROSTÁTICO INDUSTRIAL soon came the versions as ELETROSTÁTICO PRECIPITATOR OF THE MOVING ELECTRODE TYPE and “ELETROSTÁTICTIC PRECIPITATOR WITH SWITCHING ON/OFF Selective and Individual of the Emitting Electrodes

In view of the limitations of the state of the art, as to the first patent that gave rise to Precipitator PI 9500333-9 which has its basic functions of precipitation of residues. The second patent PI0803632-2 discloses an electrostatic precipitator of the moving electrode type for capturing the particles in a gas in particulate collecting electrode plates by means of the corona discharge from the discharge electrodes, by circularly moving the chains capable of reducing the extension of endless chains even if the particle collector is operated for a long period of time thereby increasing particle collection performance. Since PI patent PI0503469-8 gave the origin of the Precipitator the non-obligatory initiation of the switching on the electrode 1 could produce an insufficient gain of efficiency compared to the voltage increase that will be used in the present technology and that determines that the main accumulation occurs in the electrode 1. Simultaneously this form of sequencing reveals the best operation of the technology by observing that the main accumulation will actually occur in electrode 1.

A study was carried out to achieve a significant increase in the efficiency of these precipitators. Thus, it was found that the voltage levels necessary to obtain the retention of the sub-micron particles that are present in any industrial emission, the displacement will inevitably reach the electrode 1 and this will also be the characteristic indication that the operation of the CS is occurring satisfactorily.

Therefore, given the above-mentioned limitations contained in the current precipitators, regarding the non-mandatory of the initiation of the switching by electrode 1, so that in a random and non-sequential sequence it will produce an insufficient efficiency gain compared to the voltage increase which will be used in the present technology described below. In this way, the Industrial Electrostatic Precipitator with fixed sequence switching was developed, which conditions the switching requirement, starting with the electrode, where it determines the accumulation, with the voltage increase. In other words, for better Precipitator efficiency, the switch-off should be selective and individual to the emitting electrodes, with progressive fixed sequence of electrode 1 onwards (proceeding with 2, 3, 4 and so on, to the last electrode) with switch available before of the general reclosing and cycle restart again by the electrode 1.

Using the industrial electrostatic precipitator with fixed sequence switching will provide some key technical results with selective switching, such as:
Delay of the beats (lower rate of re-entry and wear);
Greater average layer thickness (greater weight for gravitational action×aerodynamic drag, with greater efficiency of mass collection);
Greater compaction, due to the longer time under the action of the electric field (better sponge effect of entrapment of fines in the collected mass and smaller break in the layer fall);
Better mass distribution at the end of the corridor, to reduce re-entries;
Preventive control of localized sparking and/or back corona;
Extremely significant increase in the capture of PM 0.1 to PM 2.5 (gain of 60% in retention);
Feasibility of controlling transverse effects resulting from poor flow distribution;
Flexibility of adjustment action due to changes in the activation of the relays in the campaign changes and/or seasonality.

The industrial electrostatic precipitator with fixed sequence switching may be better understood through the detailed description in accordance with the following attached figures, where:

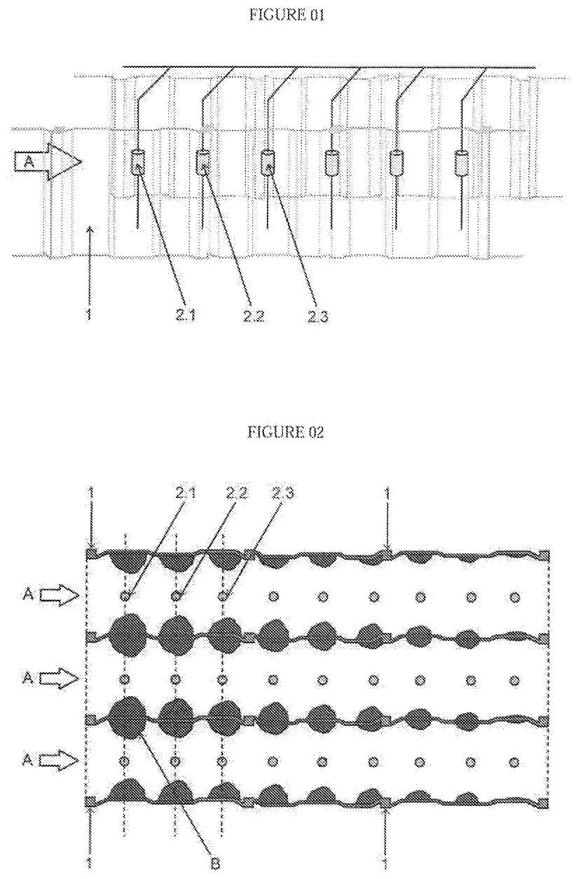

FIG. 01 Displays a perspective view of the industrial electrostatic precipitator with fixed-sequence switching.

FIG. 02 Displays a top view of the dispersion of the material in the industrial electrostatic precipitator with fixed sequence switching.

According to the above figures it can be seen that industrial electrostatic precipitator with fixed-sequence switching comprises an industrial electrostatic precipitator (P.E.) for retention of the portion of submicron particles emitted in all conventional precipitators. For this, the precipitator is composed of collector plates (1), formed by nesting segments, characterizing the structure of the precipitator with large internal corridors.

An industrial electrostatic precipitator may have a large number of corridors.

Since for each project the corridors are parallel to each other and in a same longitudinal position of the flow. And because they treat effluent materials with the same characteristics, they are therefore identical. That is, it allows for each analysis done to a single corridor can be extended to the entire Electrostatic Precipitator.

Among the collector plates 1, sequential electrodes, electrode 2.1, 2.2, 2.3 and etc. are adapted to form a line of electrodes. The amount of electrodes is proportional to the length of the corridor of the precipitator, that is, the magnitude of the design.

In order to better understand the sequence of electrode switching; the direction of flow (A) can be seen in the figures.

Thus, in order to provide the best retention efficiency of the submicron particulate as a consequence of the better distribution of the particulate retained in the collector plates (1), it is necessary that the switching voltage occur at 84 KV, followed by the disconnection of the electrodes to be initiated by the electrode (2.1), then by the electrode (2.2), and so on (necessarily starting from the first and proceeding sequentially in sequence). There will be an adequate time to switch from one electrode to the other, which will be predetermined as a consequence of the distance between the electrodes.

In FIG. 02, the distribution obtained with the switched voltage of 84 KV can be observed. Evidence of the proportionality of the particulate collector plates (1), decreasing gradually, where in the end the amount of particulate retained already minimum due to the small amount remaining until the end of the process.

When there is a narrowing of the space between the electrode and the material-accumulating surface (B) on the collector plates (1) causes sparks (voltaic arcs) to occur at this point and this is the phenomenon called here by “localized sparks”. In this case, according to FIG. 02, it is observed that this narrowing occurs at the electrode (2.1) where there will be the greatest accumulation of material (B), since it is the first one that receives the flow of the densest particulate. Currently, precipitators act on the problem of sparking by reducing the voltage across all runway emission electrodes. However, in the model proposed here, it will not allow the electrode, or electrodes, where the “localized spark” is occurring, to be turned off individually, by actuation of the electrostatic precipitator automatic control system, programmed for this, based on specific information indicating which the position of the electrode lines where the localized accumulations occur.

In practice, it may be expected that the actuation on a number of such lines, for example, for a corridor of 18 emission electrodes, the shutdown of 4 or 5 may be sufficient to achieve a large increase in efficiency of collection and service life, so switching is only necessary for these electrode lines.

This alternative of action allows the runner to continue operating with the remaining of the emission electrodes, again without localized sparks. The selective shutdown process can be repeated until, by decision of the controller, the mechanical strike is triggered, and all the emitting electrodes of the corridor in question are switched on, restarting the process. The increase in the beating interval then results in the desired effects of increasing collection efficiency and service life.

1. It is characterized by an electrostatic precipitator programmed with selective, individual, sequential switching, starting from the first electrode, electrode (2.1), and onwards with the electrode (2.2), (2.3), and so on, in order to provide the best situation to reduce the emission of particulate matter, accumulating the part retained (B) in the collector plates (1), and also the higher collection efficiency determined by the voltage increase made possible by the new technology.
